(19) United States
(12) Patent Application Publication
(10) Pub. No.: US 2006/0150804 A1
(43) Pub. Date: Jul. 13, 2006

(54) Electronic musical apparatus for displaying score or fingering

(75) Inventor: Satoshi Hiratsuka, Hamamatsu-shi (JP)

Correspondence Address: ROSSI, KIMMS & McDOWELL LLP., P.O. BOX 826, ASHBURN, VA, 20146-0826, US

(73) Assignee: Yamaha Corporation, Hamamatsu-shi (JP)

(21) Appl. No.: 11/330,964

(22) Filed: Jan. 12, 2006

(30) Foreign Application Priority Data
Jan. 12, 2005 (JP) 2005-004946

(51) Int. Cl. G10H 7/00

(52) U.S. Cl. 84/619

(57) ABSTRACT

A CPU 21 executes a program stored in an external storage device 25 to convert original music data including a series of note information in accordance with a fundamental tone for a first musical instrument into new music data including a series of note information in accordance with a fundamental tone for a second musical instrument having a fundamental tone different from that for the first musical instrument. In this case, the transposition is made by the difference between the fundamental tone for the first musical instrument included in the original music data and the fundamental tone for the second musical instrument. Further, the CPU 21 octave-shifts the note information in the new music data so as to be within the performable tone range for the second musical instrument, and octave-shifts the note information in the new music data so as to be within the tone range suitable for the performance of the second musical instrument. Then, the CPU 21 displays on a display device 12 notes and fingering based upon the note information in the new music data.

### BACKGROUND OF THE INVENTION

1. Field of the Invention

The present invention relates to an electronic musical apparatus that displays a score or fingering in accordance with a series of note information, and to a computer-readable program and a computer-readable program storage medium applied for the same apparatus.

2. Description of the Related Art

As for a transposing instrument having a fundamental tone other than tone C (e.g., wind instrument such as trumpet, alto saxophone, or the like), even if a user plays such instrument according to a score that is for a musical instrument having a fundamental tone of C such as a piano, the tone actually generated has a pitch different from that written on the score, so that a score for a transposing instrument should be prepared beforehand. However, there are a few scores for a transposing instrument. Further, there has conventionally been known, as a technique for displaying a score on a display device, the one in which a specific music part is taken out from a score composed of plural parts and the taken part is edited (see Japanese Unexamined Patent Application No. 2003-99033). There has also been known the one in which a chord name in a score for an ordinary musical instrument whose fundamental tone is C is converted into a chord name for a transposing instrument whose fundamental tone is other than C in order to display the converted chord name (see Japanese Unexamined Patent Application No. 2001-75564).

However, a unique score for a transposing instrument is required to play a wind instrument, which is a transposing instrument, as described above. Since this type of score is not so put on the market, music piece to be played is limited. Further, the conventional apparatuses that display a score do not mention the conversion between a score for an ordinary musical instrument whose fundamental tone is C and a score for a transposing instrument whose fundamental tone is other than C, so that this type of score display apparatus cannot be used.

### SUMMARY OF THE INVENTION

The present invention is accomplished in view of the above-mentioned problem, and aims to provide an electronic musical apparatus that displays a score or fingering for a second musical instrument whose fundamental tone is different, in accordance with a series of note information for a first musical instrument, thereby making it convenient to play various types of musical instruments and practice playing various types of musical instruments.

In order to attain the aforesaid object, the feature of the present invention is to provide a transposing portion that transposes a series of note information in accordance with a fundamental tone for a first musical instrument to a series of note information in accordance with a fundamental tone for a second musical instrument, that has a fundamental tone different from that of the first musical instrument, by using the fundamental tone for the first musical instrument and the fundamental tone for the second musical instrument; and a score display portion that displays a score for the second musical instrument based upon the transposed series of note information. Another feature of the present invention is to provide a fingering display portion that displays a fingering for the second musical instrument based upon the transposed series of note information, instead of the score display portion.

According to these features, if a series of note information in accordance with one fundamental tone can be obtained, a score or fingering for a musical instrument whose fundamental tone has a note name different from that of the above-mentioned fundamental tone is displayed, thereby making it convenient to play various types of musical instruments or practicing playing various types of musical instruments. In particular, there have already been a great number of a series of note information for a musical instrument whose fundamental tone is C. The use of these pieces of information makes it convenient to play and practice playing various types of transposing musical instrument whose fundamental tone is other than C.

Another feature of the present invention is that the transposing portion determines in the transposition an octave shift amount such that the series of note information in accordance with the fundamental tone for the second musical instrument is within a performable tone range for the second musical instrument. In this case, data value determined beforehand or data value inputted by a user may be utilized as the performable tone range. Specifically, the transposing portion may be composed, for example, of a tone range calculating portion that calculates a tone range of the series of note information obtained by changing the series of note information in accordance with the fundamental tone for the first musical instrument by the number of semitones corresponding to the difference between the fundamental tone for the first musical instrument and the fundamental tone for the second musical instrument; an octave shift amount determining portion that determines the octave shift amount of the series of note information in the transposition such that the calculated tone range is included within the performable tone range for the second musical instrument; and a note information calculating portion that calculates the series of note information in accordance with the fundamental tone for the second musical instrument by changing the series of note information in accordance with the fundamental tone for the first musical instrument by the determined octave shift amount and the number of semitones used for the calculation of the tone range.

According to this configuration, the converted series of note information in accordance with the fundamental tone for the second musical instrument is within the performable tone range for the second musical instrument, whereby no trouble is caused in playing or practicing playing the second musical instrument.

Still another feature of the present invention is that the transposing portion determines in the transposition an octave shift amount such that the series of note information in accordance with the fundamental tone for the second musical instrument is within a tone range suitable for the second musical instrument. The tone range suitable for the second musical instrument is included in the performable tone range and is narrower than the performable tone range. Further, the tone range suitable for the second musical instrument is a tone range by which the musical instrument can generate a satisfactory musical sound, a tone range frequently used in the normal performance, or a tone range that can be performed even by a beginner. The data value determined beforehand or data value inputted by a user may be utilized as the tone range suitable for the second musical instrument. In this case, if there is an octave shift amount by which the transposed series of note information is placed within the tone range suitable for the second musical instrument upon determining the octave shift amount by the octave shift amount determining portion, for example, this octave shift amount may be selected.

According to this configuration, the converted series of note information in accordance with the fundamental tone of the second musical instrument is within the tone range suitable for the second musical instrument, whereby a user can play or practice playing the second musical instrument under a simple and optimum condition.

Further, the present invention can be constituted and embodied not only as a device invention, but also as an invention of a computer-readable program, a computer-readable program storage medium, and process.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is an overall block diagram showing an electronic musical apparatus according to one embodiment of the present invention;

FIG. 2 is a flowchart of a pitch shift amount determining program executed by a CPU shown in FIG. 1;

FIG. 3 is a flowchart of a transposition program executed by the CPU shown in FIG. 1;

FIG. 4 is a flowchart of a display program executed by the CPU shown in FIG. 1;

FIG. 5 is a data format diagram showing one example of performance information;

FIG. 6(A) is a view showing a display example of a score;

FIG. 6(B) is a view showing a display example of fingering; and

FIG. 7 is a view showing another display example of a score and fingering.

### DESCRIPTION OF THE PREFERRED EMBODIMENT

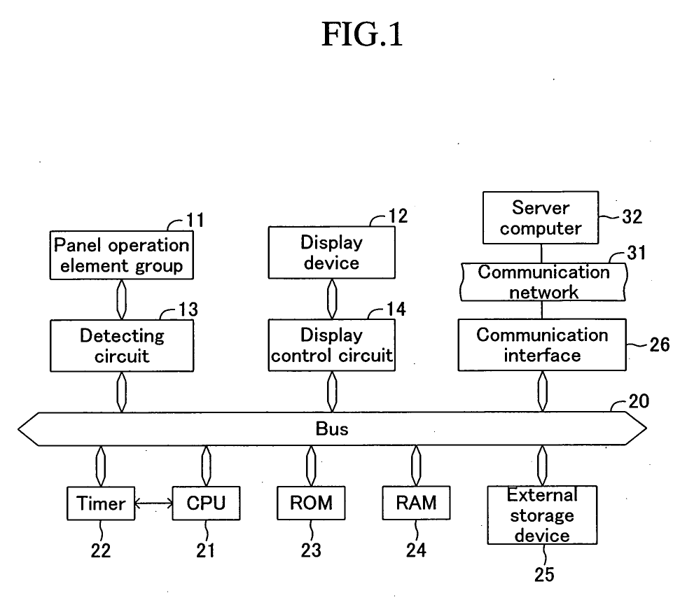

One embodiment of the present invention will be explained with reference to drawings. FIG. 1 schematically shows an electronic musical apparatus according to the present invention.

This electronic musical apparatus has a panel operation element group 11 and a display device 12. The panel operation element group 11 is mounted to an operation panel of the electronic musical apparatus and is composed of plural performance operation elements for designating an operation manner of this electronic musical apparatus. The operation of each operation element is detected by a detecting circuit 13 connected to a bus 20. The display device 12 is composed of a liquid crystal display, CRT or the like. It displays a character, number, diagram, or the like. The display manner of this display device 12 is controlled by a display control circuit 14 connected to the bus 15.

This electronic musical apparatus has the CPU 21, timer 22, ROM 23 and RAM 24, each of which is connected to the bus 20 to compose a main section of a microcomputer. The electronic musical apparatus is further provided with an external storage device 25 and a communication interface circuit 26. The external storage device 25 includes a hard disk HD and flash memory that are incorporated beforehand in this electronic musical apparatus, various recording mediums such as a compact disk CD, flexible disk FD or the like that can be inserted into the electronic musical apparatus, and a drive unit corresponding to each recording medium. The external storage device 25 can store and read a large quantity of data and programs.

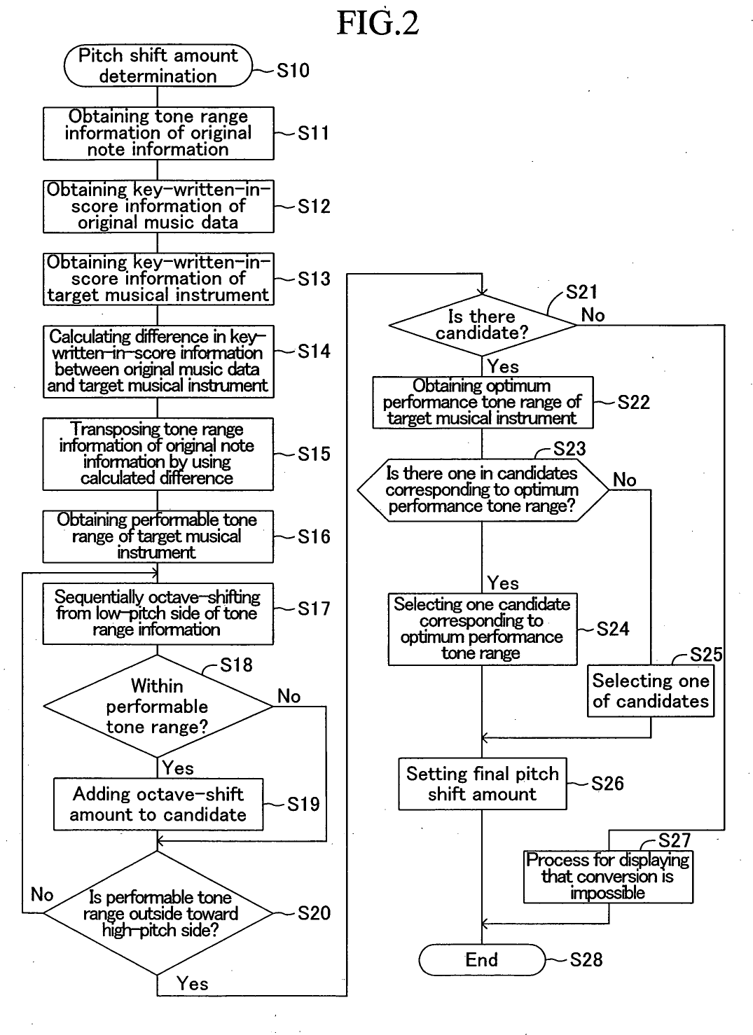

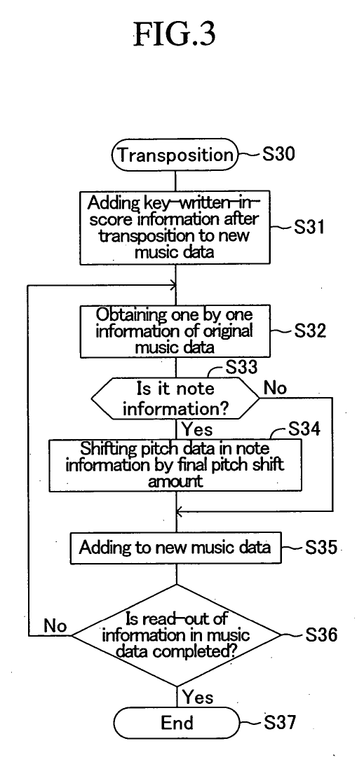

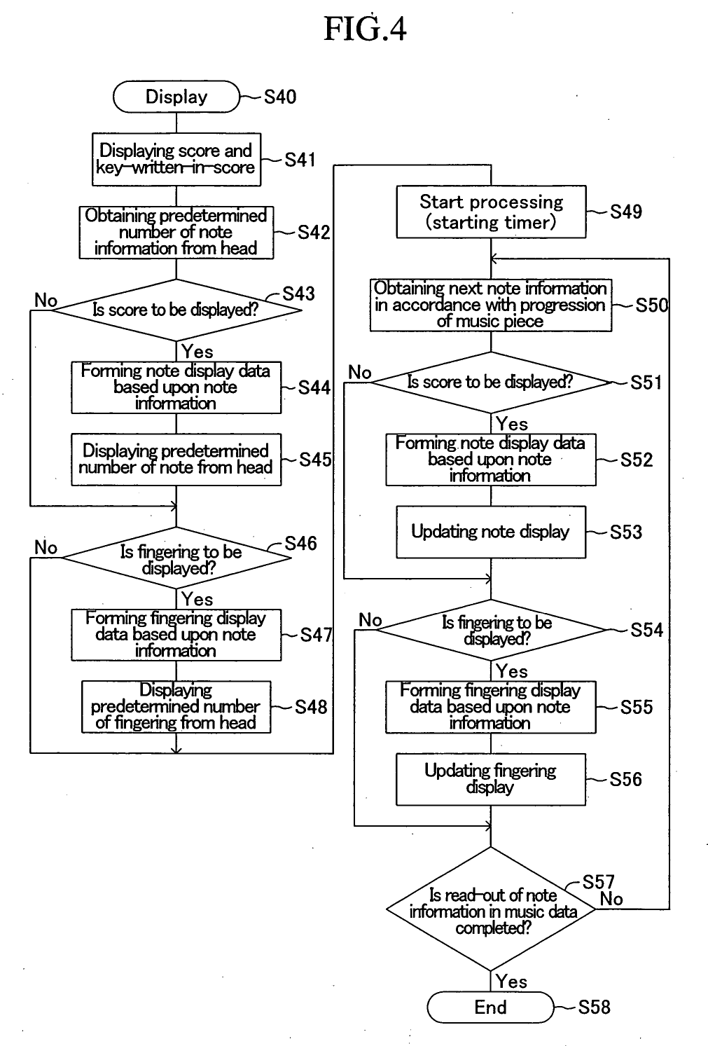

A hard disk HD, flash memory, or the like, in particular, stores a pitch shift amount determining program shown in FIG. 2, a transposition program shown in FIG. 3, a display program shown in FIG. 4, and the like. This hard disk HD, flash memory, or the like further stores plural pieces of music data each corresponding to each music piece. The programs and music data pieces may be stored beforehand in a hard disk HD or in a flash memory, may be supplied to the hard disk HD or to the flash memory from a compact disk CD or flexible disk FD, or may be externally supplied to the hard disk HD or to the flash memory via a later-described external device (e.g., server computer 32) via communication network 31.

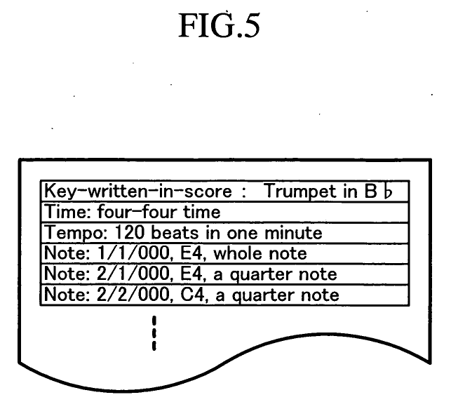

Each piece of music data is composed of key-written-in-score information, time information, tempo information, plural pieces of note information (i.e., performance information), and the like, one example of which is shown in FIG. 5. The key-written-in-score information indicates a type of a musical instrument (e.g., a trumpet) to which the music data follows and a fundamental tone (e.g., Bb) of the musical instrument. The time information indicates a time of a music piece and tempo information indicates a tempo thereof. Each of the plural pieces of note information is composed of timing data, pitch data and note length data. The timing data indicates the time of a note (i.e., performed note) from the start of the music piece successively in a bar, beat and timing in a beat (e.g., 1/1/0000). The pitch data indicates a pitch of a note (e.g., E4). The note length data indicates a length of a note (e.g., whole note). It should be noted that the music data is not limited to this format, but may be standard MIDI file format.

The communication interface circuit 26 can be connected to various external devices (e.g., server computer 32) via the communication network 31, whereby this electronic musical apparatus can receive or send various programs and data from or to various external devices.

The electronic musical apparatus having the aforesaid configuration may be a dedicated apparatus for displaying a score or fingering, but it may be applied to various music-related apparatuses such as sequencer, electronic musical instrument (electronic keyboard, electronic wind instrument), personal computer, karaoke apparatus, or the like. When this electronic musical apparatus is applied to a sequencer, electronic musical instrument or karaoke apparatus, a tone generating circuit for generating a tone signal is incorporated therein. Further, when it is applied to an electronic musical instrument, a performance operation element such as a keyboard, operation piston, or the like is attached thereto in addition to the panel operation element group 11. A MIDI interface circuit may be provided to this electronic musical apparatus for enabling the connection to other MIDI devices.

Subsequently, the operation of the embodiment thus configured will be explained. A user starts a program not shown by operating the panel operation element group 11, and selects a music piece that he/she desires the conversion of the note information (performance information). The music data of the selected music piece is read out from a hard disk HD (or flash memory) and written on the RAM 24. If there is no desired music data in the hard disk HD or the like, the desired music data can externally be obtained (e.g., from the server computer 32) via the communication network 31.

The user operates the panel operation element group 11 to cause the CPU 21 to execute the pitch shift amount determining program, transposition program and display program. The execution of the pitch shift amount determining program is started from Step S10 in FIG. 2. The CPU 21 obtains tone range information indicating a tone range of a series of note information in the music data written on the RAM 24. The music data and note information are respectively referred to as original music data and original note information hereinafter. The tone range information is composed of pitch data of a pair of notes, in a series of the original note information, each indicating the lowest tone and the highest tone. The CPU 21 extracts the lowest tone and the highest tone included in the series of the original note information, and defines the pitch data of these as the tone range information.

Then, the CPU 21 obtains the key-written-in-score information in the original music data at Step S12. If there is no key-written-in-score information in the original music data, the user obtains the key-written-in-score information from other information relating to the original music data, and inputs the key-written-in-score information by operating the panel operation element group 11. Further, if the key-written-in-score information cannot be obtained, tone C that is the fundamental tone of a normal musical instrument may be defined as the key-written-in-score information by an automatic operation or by the user's operation on the panel operation element group 11. Subsequently, the CPU 21 obtains at Step S13 the key-written-in-score information of the musical instrument (hereinafter referred to as a target musical instrument) that the user intends the conversion. In obtaining the key-written-in-score information, the user operates the panel operation element group 11 to input the key-written-in-score information. Further, the pitch shift amount determining program may correspond to a specific musical instrument and the key-written-in-score information may be set to a specific value determined beforehand.

Then, the difference in the key-written-in-score information between the original music data and the target musical instrument is calculated at Step S14. Specifically, the difference between both pieces of key-written-in-score information obtained respectively by the processes at Step S12 and Step S13 is calculated. This difference indicates a transposition amount (within one octave) of the original note information. For example, in case where the original music data relates to an alto saxophone, in which the key-written-in-score information is Eb, and the target musical instrument is a trumpet having the key-written-in-score information of Bb, the difference between the tone Eb and the actual tone is “−9 semitone”, and the difference between the tone Bb and the actual tone is “−2 semitone”. Therefore, the difference between both pieces of key-written-in-score information is “−7 semitone=(−9)−(−2)”. Further, if the original music data relates to a normal musical instrument that is not a transposing instrument wherein the key-written-in-score information is C, and the target musical instrument is a trumpet similar to the above-mentioned case, the difference between both pieces of key-written-in-score information is “+2 semitones=(0)−(−2)”.

After the process at Step S14, the CPU 21 transposes at Step S15 the obtained tone range information of the series of original note information by using the calculated difference. In this case, if the original music data relates to an alto saxophone and the target musical instrument is a trumpet, like the former case of the aforesaid example, a pair of pitch data composing the tone range information is lowered by seven semitones respectively. Further, if the original music data relates to a normal musical instrument and the target musical instrument is a trumpet, like the latter case of the aforesaid example, a pair of pitch data composing the tone range information is raised by two semitones respectively.

Subsequently, at Step S16, the CPU 21 obtains performable tone range information indicating a performable tone range of the target musical instrument. The performable tone range information is composed of pitch data of a pair of notes each indicating the lowest tone and the highest tone that enable the performance. In the case of a trumpet, for example, it is a pair of pitch data each indicating the lowest tone F#3 and the highest tone G6 in the performable tone range. In the case of an alto saxophone, it is a pair of pitch data each indicating the lowest tone Bb3 and the highest tone F#6 in the performable tone range.

In the process for obtaining the performable tone range information, performable tone range information corresponding to each type of transposing instrument is stored beforehand in the external storage device 25, and the performable tone range information corresponding to the target musical instrument selected at the Step S13 is read out. The performable tone range information may be inputted by the user's operation on the panel operation element group 11, or the performable tone range information may be obtained via the communication network 31. In case where the pitch shift amount determining program corresponds to a specific musical instrument, as described above, the performable tone range information is set to a predetermined specific value. It should be noted that this performable tone range may be composed of discrete plural ranges.

After obtaining the performable tone range, the CPU 21 repeatedly executes the circulation process made of Steps S17 to S20, wherein the CPU 21 octave-shifts the tone range information transposed by the process at the Step S15 by plural different octave-shift amounts, checks whether each piece of the octave-shifted tone range information is within the performable tone range or not, and then, extracts one or more octave-shift amounts by which the tone range information is within the performable tone range as an octave-shift candidate. Specifically, the tone range is firstly shifted by several octaves toward the low-pitch side to the degree to which the tone range is surely out of the performable tone range toward the low-pitch side by the process at the Step S17, and then, the octave-shift amount is changed toward the high-pitch side one octave by one octave for every circulation process. This repeated process is repeated until “Yes” determination is made at Step S20, i.e., until the octave-shifted tone range information is out of the performable tone range toward the high-pitch side. In case where the octave-shifted tone range information is within the performable tone range during this circulation process, “Yes” determination is made at Step S18, so that the octave-shift amount at this point is additionally stored in the RAM 24 as an octave-shift candidate by the process at Step S19. As a result, the octave-shift amount by which the tone range information is within the performable tone range is accumulated in the RAM 24 as the octave-shift candidate.

After extracting the octave-shift candidates, the CPU 21 determines whether there is an octave-shift candidate at Step S21. If there is an octave-shift candidate, the CPU 21 obtains the optimum performance tone range information indicating an optimum performance tone range of the target musical instrument at Step S22. This optimum performance tone range is included in the aforesaid performable tone range and is narrower than the performable tone range. The optimum performance tone range information is composed of pitch data of a pair of notes each indicating the lowest tone and the highest tone in the tone range optimum for the performance of the target musical instrument. Further, the optimum performance tone range is a tone range from which a satisfactory musical sound can be generated, a tone range frequently used in the normal performance, or a tone range that can be performed even by a beginner. This optimum performance tone range may agree with the performable tone range.

In the process for obtaining the optimum performance tone range information, optimum performance tone range information corresponding to each type of transposing instrument is stored beforehand in the external storage device 25, and the optimum performance tone range information corresponding to the target musical instrument selected at the Step S13 is read out. The optimum performance tone range information may be inputted by the user's operation on the panel operation element group 11, or the optimum performance tone range information may be obtained via the communication network 31. In case where the pitch shift amount determining program corresponds to a specific musical instrument, as described above, the optimum performance tone range information is set to a predetermined specific value. It should be noted that this optimum performance tone range may also be composed of discrete plural ranges.

Then, the CPU 21 checks at Step S23 whether there is the octave-shift amount, in the accumulated candidates of the octave-shift amounts, used for octave-shifting the tone range information so as to be within the optimum performance tone range. If there is the octave-shift amount corresponding to the optimum performance tone range in the candidates, the CPU 21 makes “Yes” determination at Step S23, and proceeds to Step S24. The CPU 21 selects one of the corresponding octave-shift amounts at Step S24. Specifically, if there is only one corresponding octave-shift amount, this octave-shift amount is selected. On the other hand, if there are plural corresponding octave-shift amounts, one octave-shift is selected in accordance with a predetermined rule (e.g., selecting an octave-shift amount having the smallest absolute value). Instead of this, a user may select one octave-shift amount among plural octave-shift amounts.

On the other hand, if there is no candidate of the octave-shift amount meeting the condition of the optimum performance tone range, the CPU 21 makes “No” determination at Step S23, and proceeds to Step S25. The CPU 21 selects at Step S25 one of the octave-shift amounts accumulated as the candidates. Specifically, if there is only one octave-shift amount accumulated as the candidate, this octave-shift amount is selected. On the other hand, if there are plural octave-shift amounts accumulated as the candidate, one octave-shift is selected in accordance with a predetermined rule (e.g., selecting an octave-shift amount having the smallest absolute value). Instead of this, a user may select one octave-shift amount among plural octave-shift amounts.

After the processes at Steps S24 and S25, the CPU 21 sets at Step S26 shift information composed of the transposition amount, that is the difference calculated at the Step S14, and the octave-shift amount selected by Steps S24 and S25, as a final pitch shift amount. After the process at Step S26, the CPU 21 ends the execution of the pitch shift amount determining program at Step S28. On the other hand, if there is no octave-shift amount that is to be the octave-shift candidate, the CPU 21 makes “No” determination at Step S21, and proceeds to Step S27. The CPU 21 displays on the display device 12 that the conversion of the original note information is impossible and trusts to the instruction of the user at Step S27.

After the end of the execution of this pitch shift amount determining program, the CPU 21 starts the transposition program shown in FIG. 3 from Step S30 in FIG. 3. After the start of this transposition program, the CPU 21 writes at Step S31 the key-written-in-score information after the transposition, i.e., the key-written-in-score information relating to the target musical instrument obtained at Step S13 in FIG. 2, in the RAM 24 at the head of the music data area prepared for new music data. Then, as reading out from the RAM 24 the information (see FIG. 5) after the key-written-in-score information of the original music data one by one by the process at Step S32, the CPU 21 repeatedly executes the circulation process made of Steps S32 to S36 until it is determined that read-out of all pieces of information in the original music data is completed by the process at Step S36.

During this circulation process, the CPU 21 determines whether the information read out by the process at Step S32 is note information or not at Step S33. If the read-out information is the note information, the CPU 21 makes “Yes” determination at Step S33, so that it pitch-shifts the pitch data in the read-out note information by the final pitch shift amount (transposition amount+octave-shift amount) at Step S34. Then, by the process at Step S35, the CPU 21 successively adds the read-out note information including the pitch-shifted pitch data to new music data. On the other hand, if the information read out by the process at Step S32 is not note information, the CPU 21 makes “No” determination at Step S33, so that the read-out note information is successively added to new music data by the process at Step S35.

After the read-out of all pieces of information in the original music data is completed, the CPU 21 makes “Yes” determination at Step S36 so as to end the execution of the transposition program at Step S37. By the execution of the transposition program, the original music data in the RAM 24 is converted in accordance with the fundamental tone of the target musical instrument, thereby being formed as new music data in the RAM 24. The new music data formed in the RAM 24 may be stored in the external storage device 25 for save.

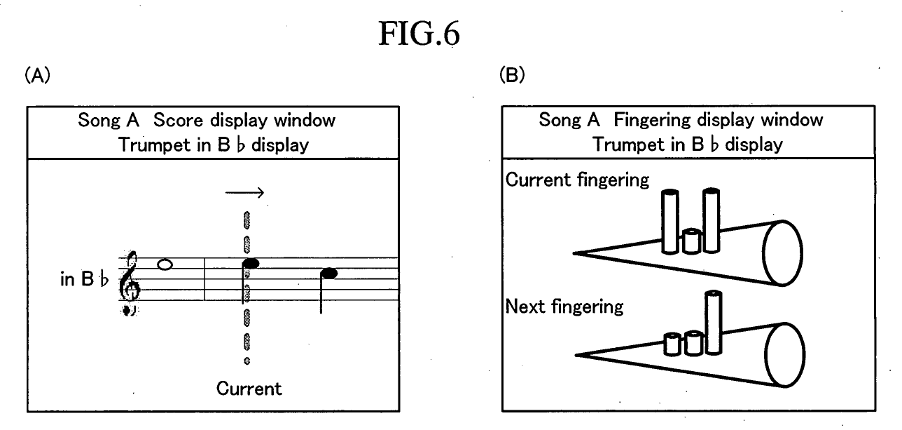

After the execution of this transposition program, the CPU starts the display program shown in FIG. 4 from Step S40 in FIG. 4. After the start of the execution of this display program, the CPU 21 reads out at Step S41 the key-written-in-score information positioned at the head of the new music data stored in the RAM 24 by the execution of the transposition program, to thereby display a score including G clef at a score displaying area on the display device 12 as shown in FIG. 6(A) as well as display the key-written-in-score of the target musical instrument before the G clef such as “in Bb” as shown in FIG. 6(A). At the same time, the title of the music data, the name of the musical instrument, and the like are displayed in the score displaying area (FIG. 6(A)) and fingering displaying area (FIG. 6(B)) on the display device 12.

Subsequently, the CPU 21 reads out at Step S42 predetermined number of note information from the head of the new music data stored in the RAM 24. In this embodiment, the predetermined number is two. The CPU 21 then determines at Step S43 whether the score is displayed or not. The determination of displaying the score is the same as the determination of displaying the fingering described later. This is instructed by the user's operation on the panel operation element group 11 by the process not shown. If displaying the score is selected, the CPU 21 forms at Step S44 note display data indicating the predetermined number of notes from the head and position data indicating the position on the score where the note is displayed, based upon the read-out note information. In the formation of the display data indicating a note, basic shape data that is stored beforehand in the external storage device 25 and indicates the shape of a note is utilized. At Step S45, the CPU 21 displays the predetermined number of notes on the displayed score as shown in FIG. 6(A) by using the formed display data and position data. In this case, only two notes are displayed on the display screen shown in FIG. 6(A) and the mark (bold broken line) indicating the current position is located at the head note position. If displaying the score is not selected, the processes at Steps S44 and S45 are not executed.

After the processes at Steps S43 to S45, the CPU 21 determines at Step S46 whether the fingering is displayed or not. If displaying the fingering is selected, the CPU 21 forms at Step S47 note display data indicating the fingering manner of the target musical instrument based upon the read-out note information. In the formation of the display data indicating a fingering manner, basic shape data that is stored beforehand in the external storage device 25 and indicates the shape of a musical instrument and basic manner of the fingering is utilized. At Step S48, the CPU 21 displays the current fingering and the next fingering as shown in FIG. 6(B) by using the formed display data. If displaying the fingering is not selected, the processes at Steps S47 and S48 are not executed.

After the processes at Steps S46 to S48, the CPU 21 waits for the instruction of the start of reproduction of the music data by the user. When the user operates the panel operation element group 11 to instruct the start of the reproduction of the music data, the CPU 21 executes at Step S49 a start process including the start of the timer 22, thereby starting to sequentially read out the note information in the new music data in accordance with the progression of the music piece (i.e., lapse of time). Thereafter, as reading out from the RAM 24 the note information (see FIG. 5) in the new music data one by one by the process at Step S50, the CPU 21 repeatedly executes the circulation process made of Steps S50 to S57 until it is determined that read-out of all pieces of note information in the new music data is completed by the process at Step S57.

If displaying the score is selected, the CPU 21 forms, by the processes of Steps S51 and S52, note display data and position data relating to the next note information read out by the process at Step S50 during the circulation process, like the processes at Steps S43 and S44. Then, at Step S53, the note display on the score is updated and the next note is displayed as shown in FIG. 6(A). At this time, the mark indicating the current position is made to correspond to the central note. In this case too, if displaying the score is not selected, the processes at Steps S52 and S53 are not executed.

If displaying the fingering is selected, the CPU 21 forms, by the processes of Steps S54 and S55, fingering display data relating to the next note information read out by the process at Step S50 after the processes at Steps S51 to S53, like the processes at Steps S46 and S47. Then, at Step S56, the fingering display is updated and the fingering manner of the next note is displayed as shown in FIG. 6(B). If displaying the fingering is not selected, the processes at Steps S55 and S56 are not executed.

After the read-out of all pieces of note information in the new music data is completed, the CPU 21 makes “Yes” determination at Step S57 so as to end the execution of the display program at Step S58. With this operation, the notes and fingering relating to the transposed new music data are successively displayed on the display device 12 in accordance with the progression of the music piece. Although the above-mentioned embodiment displays the current note, the next one note of this note and previous one note of this note, more notes or lesser notes may be displayed. Although this embodiment displays the fingering of the current note and the fingering of the next note, more fingerings may be displayed.

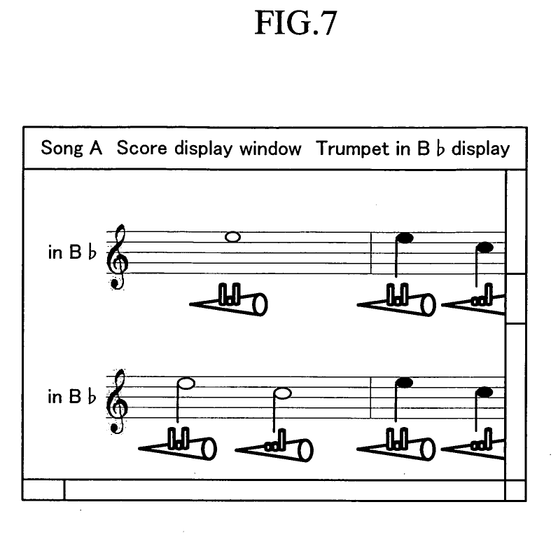

The above-mentioned program displays the note and fingering in accordance with the progression of the music piece. However, the display data and position data relating to all notes and fingering of the music piece may simultaneously be formed based upon all pieces of note information of the new music piece, and scores including all notes and fingering may simultaneously be displayed on the display device 12. In case where the display screen on the display device 12 is so small that all notes and fingering cannot be displayed, a part of the score including the notes and fingering may be switchingly displayed by the user's scroll operation using the panel operation element group 11 as shown in FIG. 7. Instead of the scroll operation by the user, the score including notes and fingering may be scroll-displayed so as to correspond to the progression of the music piece, as the music data is reproduced, like the display program.

As can be understood from the above-mentioned explanation, according to the embodiment and its modified example, so long as a series of note information in accordance with one fundamental tone can be obtained, a score and fingering for a musical instrument that has a fundamental tone whose tone name is different from that of the above-mentioned tone can be displayed by the execution of the pitch shift amount determining program shown in FIG. 2, the transposition program shown in FIG. 3 and the display program shown in FIG. 4. Therefore, it is convenient for playing various types of musical instruments and practicing playing them. In particular, a great number of series of note information for a musical instrument having tone C as a fundamental tone has already been present, and the use of the present invention is convenient for playing various types of musical instruments and practicing playing them.

The octave-shift amount in the transposition of the note information in the original music piece is determined, by the processes at Steps S11 to S21, S25 and S26 in the pitch shift amount determining program shown in FIG. 2, such that the series of note information in the new music data is within the performable tone range of the target musical instrument. Accordingly, the series of note information in the transposed new music data is within the performable tone range of the target musical instrument, whereby there is no trouble in playing or practicing playing the target musical instrument. Further, the octave-shift amount is determined such that the series of note information is within the tone range suitable for the performance of the target musical instrument by the addition of the processes at Steps S22 to S24 in the pitch shift amount determining program shown in FIG. 2. Accordingly, the series of note information in the new music data is within the tone range suitable for the performance of the target musical instrument, whereby a user can play or practice playing the target musical instrument under a simple and optimum condition.

Upon embodying the present invention, the invention is not limited to the aforesaid embodiment and its modified example, but various modifications can be made without departing from the spirit of the invention.

For example, in the aforesaid embodiment, the whole piece of the original music data can be simultaneously obtained from the external storage device 25 such as a hard disk or the server computer 32 via the communication network 31. However, instead of this, the present invention can be applied to the case wherein music data in a stream format is received from the server computer 32 or other external apparatuses via the communication network 31, and the music data is processed without being accumulated in the external storage device 25.

Although the tone range is determined based upon all pieces of note information in the original music data in the aforesaid embodiment, the tone range may be estimated based upon a part of the note information. Further, in case where tone range information indicating the used tone range is prepared in the music data, this tone range information can be utilized.

In the aforesaid embodiment, the automatic process is made upon transposing the note information in the original music data such that the note information is within the performable tone range and optimum performance tone range of the target musical instrument. However, instead of this, a user may select whether the octave-shift in the transposition is carried out or not. Whether the octave-shift in the transposition is carried out or not and its shift amount may be displayed on the display device 12 in order to let the user to know. Further, a user may instruct the process other than the octave-shift process for placing the note information within the performable tone range.

The aforesaid embodiment does not describe the edition of the transposed note information. However, the music data including the note information after the transposition may be edited by a user. The edited music data may be stored in the external storage device 25 in the form of the key of the original music data or the key after the transposition.

What is claimed is:

1. An electronic musical apparatus comprising:
a transposing portion that transposes a series of note information in accordance with a fundamental tone for a first musical instrument to a series of note information in accordance with a fundamental tone for a second musical instrument, that has a fundamental tone different from that of the first musical instrument, by using the fundamental tone for the first musical instrument and the fundamental tone for the second musical instrument; and
a score display portion that displays a score for the second musical instrument based upon the transposed series of note information.

2. An electronic musical apparatus according to claim 1, wherein
the transposing portion determines in the transposition an octave shift amount such that the series of note information in accordance with the fundamental tone for the second musical instrument is within a performable tone range for the second musical instrument.

3. An electronic musical apparatus according to claim 2, wherein the transposing portion comprises
a tone range calculating portion that calculates a tone range of the series of note information obtained by changing the series of note information in accordance with the fundamental tone for the first musical instrument by the number of semitones corresponding to the difference between the fundamental tone for the first musical instrument and the fundamental tone for the second musical instrument;
an octave shift amount determining portion that determines the octave shift amount of the series of note information in the transposition such that the calculated tone range is included within the performable tone range for the second musical instrument; and
a note information calculating portion that calculates the series of note information in accordance with the fundamental tone for the second musical instrument by changing the series of note information in accordance with the fundamental tone for the first musical instrument by the determined octave shift amount and the number of semitones used for the calculation of the tone range.

4. An electronic musical apparatus according to claim 2, wherein
the transposing portion further determines in the transposition an octave shift amount such that the series of note information in accordance with the fundamental tone for the second musical instrument is within a tone range suitable for the performance of the second musical instrument.

5. An electronic musical apparatus comprising:
a transposing portion that transposes a series of note information in accordance with a fundamental tone for a first musical instrument to a series of note information in accordance with a fundamental tone for a second musical instrument, that has a fundamental tone different from that of the first musical instrument, by using the fundamental tone for the first musical instrument and the fundamental tone for the second musical instrument; and
a fingering display portion that displays a fingering for the second musical instrument based upon the transposed series of note information.

6. An electronic musical apparatus according to claim 5, wherein
the transposing portion determines in the transposition an octave shift amount such that the series of note information in accordance with the fundamental tone for the second musical instrument is within a performable tone range for the second musical instrument.

7. An electronic musical apparatus according to claim 6, wherein the transposing portion comprises
a tone range calculating portion that calculates a tone range of the series of note information obtained by changing the series of note information in accordance with the fundamental tone for the first musical instrument by the number of semitones corresponding to the difference between the fundamental tone for the first musical instrument and the fundamental tone for the second musical instrument;
an octave shift amount determining portion that determines the octave shift amount of the series of note information in the transposition such that the calculated tone range is included within the performable tone range for the second musical instrument; and
a note information calculating portion that calculates the series of note information in accordance with the fundamental tone for the second musical instrument by changing the series of note information in accordance with the fundamental tone for the first musical instrument by the determined octave shift amount and the number of semitones used for the calculation of the tone range.

8. An electronic musical apparatus according to claim 5, wherein
the transposing portion further determines in the transposition an octave shift amount such that the series of note information in accordance with the fundamental tone for the second musical instrument is within a tone range suitable for the performance of the second musical instrument.

9. A computer-readable program including:
a transposing step for transposing a series of note information in accordance with a fundamental tone for a first musical instrument to a series of note information in accordance with a fundamental tone for a second musical instrument, that has a fundamental tone different from that of the first musical instrument, by using the fundamental tone for the first musical instrument and the fundamental tone for the second musical instrument; and
a score display step for displaying a score for the second musical instrument based upon the transposed series of note information.

10. A computer-readable program including:
a transposing step for transposing a series of note information in accordance with a fundamental tone for a first musical instrument to a series of note information in accordance with a fundamental tone for a second musical instrument, that has a fundamental tone different from that of the first musical instrument, by using the fundamental tone for the first musical instrument and the fundamental tone for the second musical instrument; and
a fingering display step for displaying a fingering for the second musical instrument based upon the transposed series of note information.

11. A computer-readable program storage medium for storing a computer-readable program, the computer-readable program including:
a transposing step for transposing a series of note information in accordance with a fundamental tone for a first musical instrument to a series of note information in accordance with a fundamental tone for a second musical instrument, that has a fundamental tone different from that of the first musical instrument, by using the fundamental tone for the first musical instrument and the fundamental tone for the second musical instrument; and
a score display step for displaying a score for the second musical instrument based upon the transposed series of note information.

12. A computer-readable program storage medium for storing a computer-readable program, the computer-readable program including:
a transposing step for transposing a series of note information in accordance with a fundamental tone for a first musical instrument to a series of note information in accordance with a fundamental tone for a second musical instrument, that has a fundamental tone different from that of the first musical instrument, by using the fundamental tone for the first musical instrument and the fundamental tone for the second musical instrument; and
a fingering display step for displaying a fingering for the second musical instrument based upon the transposed series of note information.
